(19) United States
(12) Patent Application Publication
(10) Pub. No.: US 2012/0091900 A1
(43) Pub. Date: Apr. 19, 2012

(54) OUTDOOR LIGHTING SYSTEM

(76) Inventor: Bernard Fournier, Delson (CA)

(21) Appl. No.: 13/270,888

(22) Filed: Oct. 11, 2011

Related U.S. Application Data
(60) Provisional application No. 61/393,433, filed on Oct. 15, 2010.
(60) Provisional application No. 61/428,487, filed on Dec. 30, 2010.

(51) Int. Cl. H05B 37/02

(52) U.S. Cl. 315/154

(57) ABSTRACT

According to an embodiment of the present invention, a lighting system includes a low-voltage power supply (for example, including a transformer, solar cell, battery, etc.), power conductor(s) electrically connected with the low-voltage power supply, and two low-voltage light fixtures electrically connected to the power conductor(s). Each of the light fixtures has a respective control portion. The control portions simultaneously enable different operating modes for the first and second light fixtures. Such modes could include a constantly on/off mode, a dusk-to-dawn mode, a dusk to a time period after dusk mode, half-power dimming mode, or a motion detection mode.

This application claims the benefit of priority from U.S. Provisional Application Nos. 61/393,433 and 61/428,487, filed on Oct. 15, 2010 and Dec. 30, 2010 respectively, which are incorporated herein in their entireties.

### BACKGROUND OF THE INVENTION

Certain outdoor lighting systems include a plurality of fixtures. The fixtures may be connected to a power bus through power conductors. The power bus may be a low-voltage bus, such as 12VAC, 12VDC, 16VAC, 16VDC, etc. The light fixtures may be wired in a star or daisy-chain configuration. Such outdoor lighting systems may be controllable at a power supply—for example, a low-voltage power supply, transformer, etc. The control may be a timer, motion detector, dimmer, photodetector, a combination thereof, and/or the like. In such a topology, all of the fixtures may be controlled together.

It may be desirable for an outdoor lighting system to provide for a greater variety of landscape lighting effects.

### SUMMARY OF THE INVENTION

According to an embodiment of the present invention, a lighting system includes a low-voltage power supply (for example, including a transformer, solar cell, battery, etc.), power conductor(s) electrically connected with the low-voltage power supply, and two low-voltage light fixtures electrically connected to the power conductor(s). Each of the light fixtures has a respective control portion. The control portions simultaneously enable different operating modes for the first and second light fixtures. Such modes could include a constantly on/off mode, a dusk-to-dawn mode, a dusk to a time period after dusk mode, half-power dimming mode, or a motion detection mode.

The control portions may have photodetectors. The control portions may also have mufti-mode actuators that can actuate one of the operating modes. The control portions may also have switch controls. A switch control in one of the fixtures may be capable of switching a lamp in that fixture but not in the other fixture. The fixtures may be responsive to a motion detector. For example, the fixtures may receive a control signal directly from such motion detector (for example, over a power conductor). Additionally, an electrical connection between the power supply and the power conductor(s) may be interrupted when the motion detector determines that no motion is present. The system may also include a third low-voltage light fixture electrically connected with the power conductor(s). The third fixture does not have a control portion. The third fixture may still respond to the motion detector.

According to an embodiment of the present invention, a method for operating a lighting system includes providing power from a low-voltage power supply through power conductor(s) to two low-voltage light fixtures. The first fixture is operated in a first mode according to a first control portion in the first fixture. Simultaneously, the second fixture is operated in a second mode (different from the first mode) according to a second control portion in the second fixture. Such modes could include a constantly on/off mode, a dusk-to-dawn mode, a dusk to a time period after dusk mode, half-power dimming mode, or a motion detection mode. The method may also include operating a third low-voltage light fixture that does not have a control portion.

### BRIEF DESCRIPTION OF SEVERAL VIEWS OF THE DRAWINGS

FIGS. 1A and 1B illustrate an outdoor light fixture, according to embodiments of the present invention.

FIG. 2 illustrates an outdoor lighting system, according to embodiments of the present invention.

FIG. 3 illustrates an outdoor lighting system, according to embodiments of the present invention.

FIG. 4 illustrates a flowchart of a method for operating an outdoor lighting system, according to embodiments of the present invention.

The foregoing summary, as well as the following detailed description of certain embodiments of the present invention, will be better understood when read in conjunction with the appended drawings. For the purposes of illustration, certain embodiments are shown in the drawings. It should be understood, however, that the claims are not limited to the arrangements and instrumentality shown in the attached drawings. Furthermore, the appearance shown in the drawings is one of many ornamental appearances that can be employed to achieve the stated functions of the system.

### DETAILED DESCRIPTION OF THE INVENTION

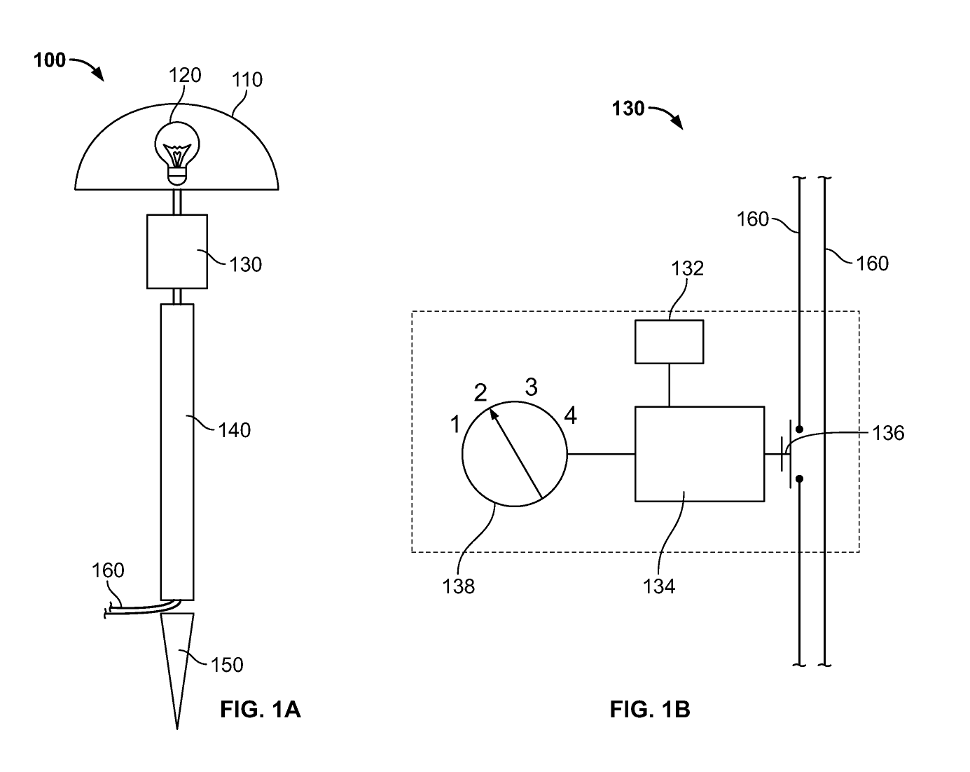

FIG. 1A illustrates an outdoor light fixture 100, according to embodiments of the present invention. The outdoor light fixture 100 may be a low-voltage light fixture. The fixture 100 may include a spike 150, a base 140, power conductors 160, a control portion 130, a lamp 120, and lamp housing 110. The spike 150 may facilitate mounting the fixture 100 into the ground. The fixture 100 may receive or otherwise be electrically connected with one or more power conductors 160 (hereinafter, “power conductors”), which may travel through the base 140 and into the control portion 130. The power conductors 160 may also travel to the lamp housing 110. The lamp 170 may receive power from the power conductors 160 and produce a visible light when power is being supplied.

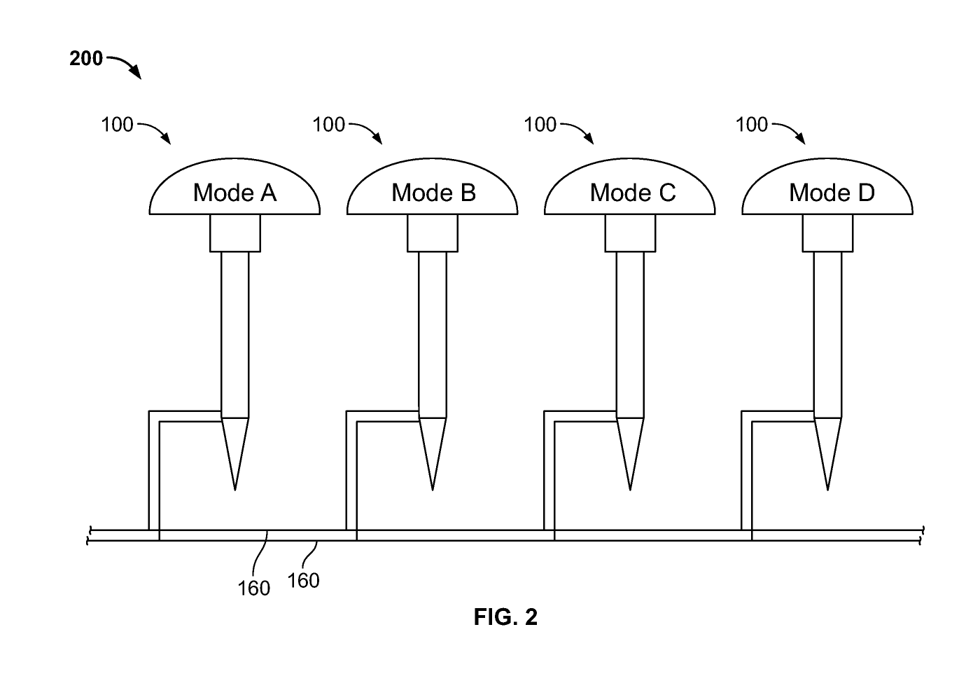

In an embodiment, a light fixture without a control can be adapted and retrofitted to include a control portion 130. For example, in some existing light fixtures, a base may be connected to the lamp housing. The base may be removed from the lamp housing. The control portion 130 may then be inserted. Appropriate electrical connections can be made to the control portion (see, for example, FIG. 2). The control portion 130 may be powered by the power conductors. The lamp housing may then be attached to the control portion 130.

FIG. 1B illustrates a control portion 130 of a light fixture 100, according to embodiments of the present invention. The control portion 130 may include a switch 136, a switch control 134, a photodetector, 132 and a mufti-mode actuator 138. The switch control 134 may interrupt the flow of current through one or both of the power conductors 160 (for example, power and common). The switch 136 may be controlled by the switch control 134. The switch control 134 may receive inputs from one or more input devices, such as the photodetector 132 and the mufti-mode actuator 138. Other actuators or input devices are possible, such as timer inputs and motion detectors. The switch control 134 may responsively switch the current flowing through the power conductors 160 according to the state of input devices (which may include external control devices not shown in FIG. 1B).

In addition to receiving inputs and generating output(s) to control the switch 136, the switch control 134 may include a timer. The switch control 134 may include a processor to responsively switch the current flowing through the power conductors 160 according to the state of the input devices.

The multi-mode actuator 138 may be a single actuator or a combination of actuators. For example, the multi-mode actuator 138 may be a four-way switch or a combination of individual switches. The state of the mufti-mode actuator 138 may determine a mode of operation for the light fixture 100. The switch control 134 may recognize the state of the mufti-mode actuator 138 and responsively implement a selected mode. It may be possible to define various different modes such as constantly on/off, dusk-to-dawn, dusk to a time period (for example, five hours) after dusk, half-power dimming, or motion detection, for example.

FIG. 2 illustrates an outdoor lighting system 200, according to embodiments of the present invention. The system 200 may include a plurality of fixtures 100 electrically connected with power conductors 160. Each of the fixtures 100 may operate in a different mode simultaneously (such as the modes determined by the mufti-mode actuator shown in FIG. 1B). For any of the fixtures, a given fixture's control portion may switch (through a switch control) power from the power conductors 160 to the given fixture's lamp. However, a control portion in one fixture 100 may not be capable of switching power supplied from the power conductors 160 to a lamp of a different fixture.

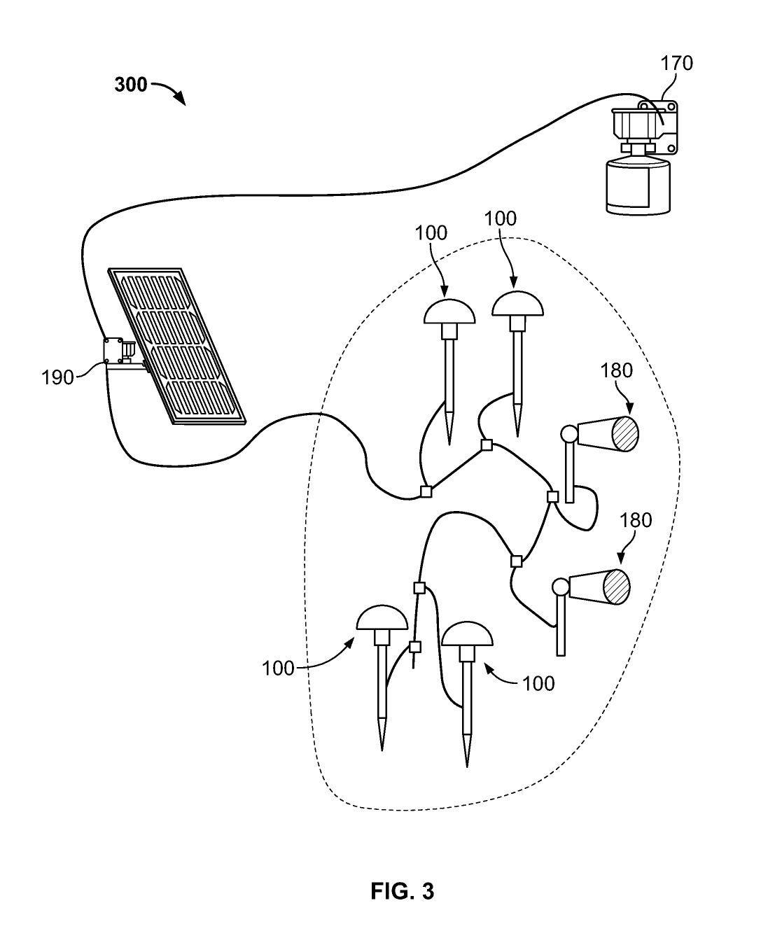

FIG. 3 illustrates an outdoor lighting system 300, according to embodiments of the present invention. The system 300 may include a plurality of fixtures 100 and/or 180, a motion detector 170, power conductors 160, and a power supply 190.

The power supply may be a low-voltage power supply, for example 12VAC, 12VDC, 16VAC, 16VDC, etc. The power supply 190 may include a transformer, solar panel, battery, etc. The power supply 190 may be electrically connected to the power conductors 160 and configured to provide electrical power to the light fixtures 100/180 through the power conductors 160. There may be batteries associated with the system 300 to store energy generated by a solar panel. The batteries may be a different component of the system 300 or integrated with one or more illustrated components of the system 300 (for example, motion detector 170, power supply 190, and/or fixtures 100/180).

The motion detector 170 may include a physical mechanism or electronic sensor that quantifies motion that can be either integrated with or connected to other devices to indicate the presence of a moving object within the field of view. The motion detector 170 may include one or more sensors, such as passive infrared sensors (PIR), ultrasonic sensors, and/or microwave sensors. The motion detector 170 may provide a signal to switch power on or off to the light fixtures 100/180 depending on whether movement is detected. The motion detector 170 may contain a power switch or may provide a control signal (for example, through the power conductors 160) to drive a power switch located elsewhere in the system—for example, in the power supply 190 or the fixtures 100/180. If the motion detector 170 determines that motion is present, then an electrical connection between the power supply 190 and the power conductors 160 may be interrupted. The power supply 190 and/or motion detector 170 may include mounting portions for mounting to structures, such as a wall or fence. The power supply 190 and motion detector 170 may be mounted in the same location or may be mounted in separate locations.

A light fixture 180 may not have a control portion, but may otherwise be similar to light fixture 100. For example, the fixture 180 may have a spike, a lamp, housing, or base. The fixture 180 may be electrically connected with the power conductors 160. Like a fixture 100, the fixture 180 may respond to the motion detector 170 (for example, turn on/off in response to the determination of motion).

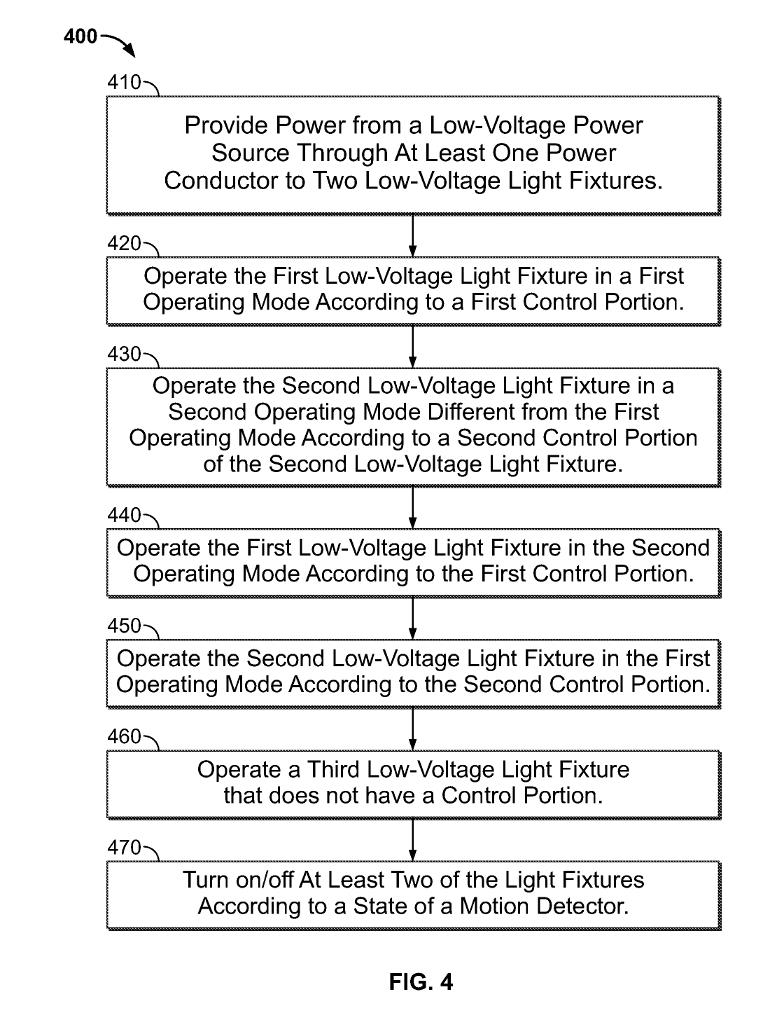

FIG. 4 illustrates a flowchart 400 of a method for operating an outdoor lighting system, according to embodiments of the present invention. The lighting system may be similar to the one shown in FIG. 3. Some steps can be omitted or performed in a different order.

At step 410, power is provided from a low-voltage power supply through at least one power conductor to two low-voltage light fixtures. At step 420 the first fixture is operated in a first operating mode according to a first control portion of the first fixture. At step 430 (which may be performed simultaneously with step 420), the second low-voltage light fixture operates in a second operating mode different from the first operating mode according to a second control portion of the second low-voltage light fixture. At step 440, the first low-voltage light fixture is operated in the second operating mode according to the first control portion. At step 450 (which may be performed simultaneously with step 440), the second low-voltage light fixture is operated in the first operating mode according to the second control portion. At step 460 (which may be performed simultaneously with any or all of the previous steps), a third low-voltage light fixture that does not have a control portion is operated. At step 470, at least two of the light fixtures are turned on/off according to a state of a motion detector.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A lighting system comprising:
a low-voltage power supply;
at least one power conductor electrically connected with the low-voltage power supply;
a first low-voltage light fixture electrically connected with the at least one power conductor and including a first control portion configured to enable a plurality of operating modes for the first low-voltage light fixture;
a second low-voltage light fixture electrically connected with the power conductor and including a second control portion configured to enable a plurality of operating modes for the second low-voltage light fixture; and
wherein the first control portion and the second control portion are configured to simultaneously enable different ones of the plurality of operating modes to the first low-voltage light fixture and the second low-voltage light fixture respectively.

2. The lighting system of claim 1, wherein the plurality of operating modes include at least two of a constantly on/off mode, a dusk-to-dawn mode, a dusk to a time period after dusk mode, half-power dimming mode, or a motion detection mode.

3. The lighting system of claim 1, wherein the low-voltage power supply comprises a solar cell and a battery.

4. The lighting system of claim 1, wherein the first control portion comprises a first photodetector and the second control portion comprises a second photodetector.

5. The lighting system of claim 1, wherein the first control portion comprises a first multi-mode actuator configured to actuate one of the plurality of operating modes; and
wherein the second control portion comprises a second multi-mode actuator configured to actuate one of the plurality of operating modes.

6. The lighting system of claim 1, wherein the first control portion comprises a first switch control and the second control portion comprises a second switch control;
wherein the first switch control is configured to switch power from the at least one power conductor to a lamp of the first low-voltage lighting fixture but not to a lamp of the second low-voltage lighting fixture; and
wherein the second switch control is configured to switch power from the at least one power conductor to a lamp of the second low-voltage lighting fixture but not a lamp of the first low-voltage lighting fixture.

7. The lighting system of claim 1, wherein each of the first low-voltage light fixture and the second low-voltage light fixture are configured to respond to a motion detector while operating in at least one of the plurality of operating modes.

8. The lighting system of claim 7, wherein the first low-voltage light fixture and the second low-voltage light fixture are each configured to receive at least one control signal directly from the motion detector.

9. The lighting system of claim 8, wherein the at least one power conductor is configured to carry the at least one control signal from the motion detector to the first low-voltage light fixture and the second low-voltage light fixture.

10. The lighting system of claim 7, wherein an electrical connection between the low-voltage power supply and the at least one power conductor is configured to be interrupted when the motion detector determines that no motion is present.

11. The lighting system of claim 1, further including a third low-voltage light fixture electrically connected with the at least one power conductor but not including a control portion.

12. The lighting system of claim 11, wherein each of the first low-voltage light fixture and the second low-voltage light fixture are configured to respond to a motion detector while operating in at least one of the plurality of operating modes; and
wherein the third low-voltage light fixture is configured to respond to the motion detector.

13. The lighting system of claim 12, wherein the first low-voltage light fixture and the second low-voltage light fixture are each configured to receive at least one control signal directly from the motion detector.

14. The lighting system of claim 13, wherein the at least one power conductor is configured to carry the at least one control signal from the motion detector to the first low-voltage light fixture and the second low-voltage light fixture.

15. The lighting system of claim 12, wherein an electrical connection between the low-voltage power supply and the at least one power conductor is configured to be interrupted when the motion detector determines that no motion is present.

16. A method for operating a lighting system, the method comprising:
providing power from a low-voltage power supply through at least one power conductor to a first low-voltage light fixture and a second low-voltage light fixture;
operating the first low-voltage light fixture in a first operating mode according to a first control portion of the first low-voltage light fixture; and
simultaneously operating the second low-voltage light fixture in a second operating mode different from the first operating mode according to a second control portion of the second low-voltage light fixture.

17. The method of claim 16, wherein the first operating mode and the second operating mode include different ones of a constantly on/off mode, a dusk-to-dawn mode, a dusk to a time period after dusk mode, half-power dimming mode, or a motion detection mode.

18. The method of claim 16, further comprising:
operating the first low-voltage light fixture in the second operating mode according to a first control portion of the first low-voltage light fixture; and
simultaneously operating the second low-voltage light fixture in the first operating mode according to a second control portion of the second low-voltage light fixture.

19. The method of claim 18, further comprising operating a third low-voltage light fixture, wherein the third low-voltage light fixture does not include a control portion.

20. The method of claim 16, further comprising turning off or on both of the first low-voltage light fixture and the second low-voltage light fixture according to a state of a motion detector.
